(19) United States
(12) Patent Application Publication
(10) Pub. No.: US 2026/0127635 A1
(43) Pub. Date: May 7, 2026

(54) ANALYSIS DEVICE, ANALYSIS METHOD, AND RECORDING MEDIUM

(71) Applicant: NEC CORPORATION, Minato-ku, Tokyo (JP)

(72) Inventors: Takahiro MATSUI, Tokyo (JP); Takashi SHIMIZU, Tokyo (JP); Shinji FUNAI, Tokyo (JP); Yoshiya UOTANI, Tokyo (JP)

(73) Assignee: NEC CORPORATION, Minato-ku, Tokyo (JP)

(21) Appl. No.: 19/117,102

(22) PCT Filed: Dec. 27, 2022
(86) PCT No.: PCT/JP2022/048072

§ 371 Date: Mar. 31, 2025

(51) Int. Cl. G06Q 30/0242; G06T 7/20; G06V 20/52; G06V 40/20

(52) U.S. Cl. CPC G06Q 30/0246; G06T 7/20; G06V 20/52; G06V 40/20

(57) ABSTRACT

This analysis device comprises: a detection means that detects a customer reaction to content that is output to an output device in a store; an acquisition means that acquires information pertaining to the purchasing behavior of the customer after detection has been performed; an analysis means that performs analysis on the basis of the information pertaining to the purchasing behavior; and an output means that outputs the results of the analysis.

### TECHNICAL FIELD

The present disclosure relates to an analysis device, an analysis method, and a recording medium.

### BACKGROUND ART

In order to check the effect of the target advertisement, it is necessary to check the purchasing behavior of the customer who has seen the advertisement. For example, PTL 1 discloses that a viewer of content is detected based on a captured image acquired by an imaging means installed in a store, a moving direction of the viewer after viewing the content is detected, and a guiding effect of the content is analyzed based on the detected moving direction of the viewer.

### CITATION LIST

### Patent Literature

PTL 1: JP 2017-162221 A

### SUMMARY OF INVENTION

### Technical Problem

In the technique described in PTL 1, a moving direction of a viewer after viewing content is detected, and a guiding effect of the content is analyzed based on the detected moving direction of the viewer. However, analysis may be insufficient only in the moving direction of the customer.

An object of the present disclosure is to provide an analysis device capable of analyzing a product in content from a plurality of viewpoints.

### Solution to Problem

An analysis device according to an aspect of the present disclosure includes: a detection means that detects a customer reaction to content that is output to any of output devices in a store; an acquisition means that acquires information pertaining to the purchasing behavior of the customer after detection has been performed; an analysis means that performs analysis based on the information pertaining to the purchasing behavior; and an output means that outputs the results of the analysis.

An analysis method according to an aspect of the present disclosure causes a computer to execute: detecting a customer reaction to content output to any of output devices in a store; acquiring information pertaining to a purchasing behavior of the customer after the detection; performing analysis based on information pertaining to the purchasing behavior; and outputting a result of analysis.

A recording medium according to an aspect of the present disclosure stores a program for causing a computer to execute: detecting a customer reaction to content output to any of output devices in a store; acquiring information pertaining to a purchasing behavior of the customer after the detection; performing analysis based on information pertaining to the purchasing behavior; and outputting a result of analysis.

### Advantageous Effects of Invention

According to the present disclosure, it is possible to provide an analysis device capable of analyzing a product in content from a plurality of viewpoints.

### BRIEF DESCRIPTION OF DRAWINGS

FIG. 1 is an explanatory diagram illustrating an example of a use scene of an analysis device according to a first example embodiment.

FIG. 2 is a block diagram illustrating a configuration example of an analysis system including the analysis device according to the first example embodiment.

FIG. 3 is a diagram illustrating a hardware configuration in which the analysis device according to the first example embodiment is implemented by a computer device and its peripheral device.

FIG. 4 is an output example in which the results of analysis are output in the first example embodiment.

FIG. 5 is a flowchart illustrating an operation of the analysis device according to the first example embodiment.

FIG. 6 is a block diagram illustrating a configuration example of an analysis system including an analysis device according to a second example embodiment.

FIG. 7 is an output example of the results of analysis on appeal power of content by an output unit in the second example embodiment.

FIG. 8 is an output example of the result of analysis on appeal power of a product by an output unit in the second example embodiment.

FIG. 9 is a flowchart illustrating an operation of the analysis device according to the second example embodiment.

### EXAMPLE EMBODIMENT

Hereinafter, example embodiments of an analysis device, an analysis method, and a non-transitory recording medium recording a program according to the present disclosure will be described in detail with reference to the drawings. The present example embodiment does not limit the disclosed technology.

In the present example embodiment, content related to a product sold in a store to a customer who is shopping is output to the output device in the store. The store is, for example, a retail store such as a supermarket and a home center. The content in the present example embodiment is sales information of a specific product to be recommended to a customer, and includes a feature, a price, a display place, inventory information, and the like of the product. In the present example embodiment, a product included in content is referred to as a target product.

Examples of the output device include a customer terminal such as a tablet terminal provided in a shopping cart or a customer's own terminal, a signage, and a speaker. The output device outputs information pertaining to the recommended product as a voice, a moving image, or a still image. An installation place of the output device is not particularly limited. For example, the output device may be installed near an entrance of a store, may be installed on a display shelf, a door of the display shelf, a window of the store, a ceiling, or the like, or may be installed on a floor of the store. The output device may include a projector, and may project content on a wall or a floor of a store.

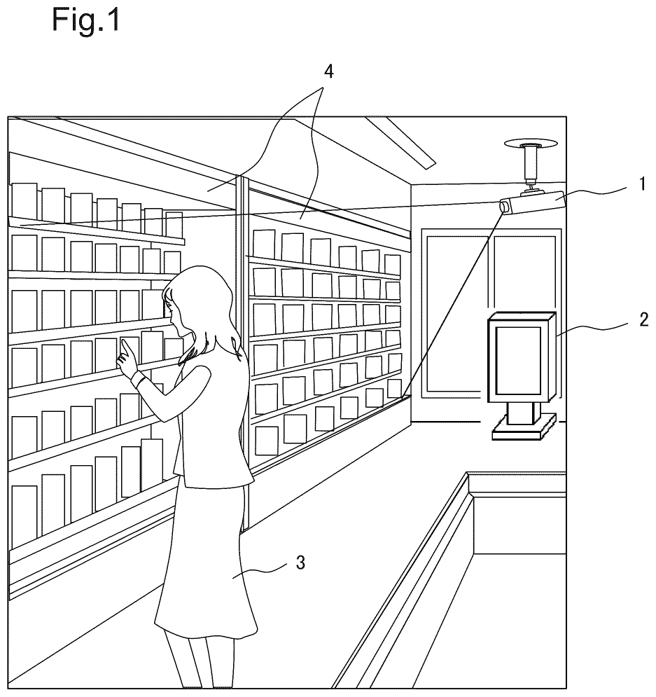

FIG. 1 is an explanatory diagram illustrating an example of a use scene of an analysis device in the present example embodiment. In an analysis system 10 including an analysis device 100, an imaging device 1 images a behavior of a customer 3 in front of a display shelf 4 in response to the content output to an output device 2. Then, the imaging device 1 transmits a video signal indicating the captured image to the analysis device 100.

The imaging device 1 is, for example, a monitoring camera installed in a store or the like or a camera provided in a signage. For example, the imaging device 1 is installed at a predetermined position where a reaction of the customer 3 to the content and the display shelf 4 can be imaged. Examples of the installation place of the camera include a position where a passage such as a ceiling or a passage of the floor can be imaged, a position where a front of a display shelf such as a camera in front of a shelf can be imaged, a front of a register of the store, and the like, but the number of cameras and the installation place are not particularly limited.

An identifier (ID) or the like for identifying the imaging device 1 is allocated to the imaging device 1 in advance. In the store, the reaction of the customer 3 to the content and the display shelf 4 may be imaged by different imaging devices. For example, an imaging device provided in the signage may image a reaction of the customer 3 to the content, and the monitoring camera may image the display shelf 4. The imaging device 1 acquires a captured image. At this time, the imaging device 1 refers to, for example, its own clock or the like, and associates the imaging time, which is the time when the captured image is acquired, with the acquired captured image. In this manner, the imaging device 1 acquires the captured image showing the reaction of the customer 3 and the state of the display shelf 4 and the like.

The video captured by the imaging device 1 may be a moving image or continuous still images. In the present example embodiment, the captured image acquired by the imaging device 1 may be a color image (hereinafter, the image is referred to as an RGB (Red Green Blue) image) or an image in a color space other than the RGB image.

As described above, the imaging device 1 transmits image data indicating the acquired captured image to the analysis device 100. The analysis device 100 stores the received image data in a storage device 505. The imaging device 1 may store the image data inside the imaging device 1 or in a storage device different from the analysis device 100.

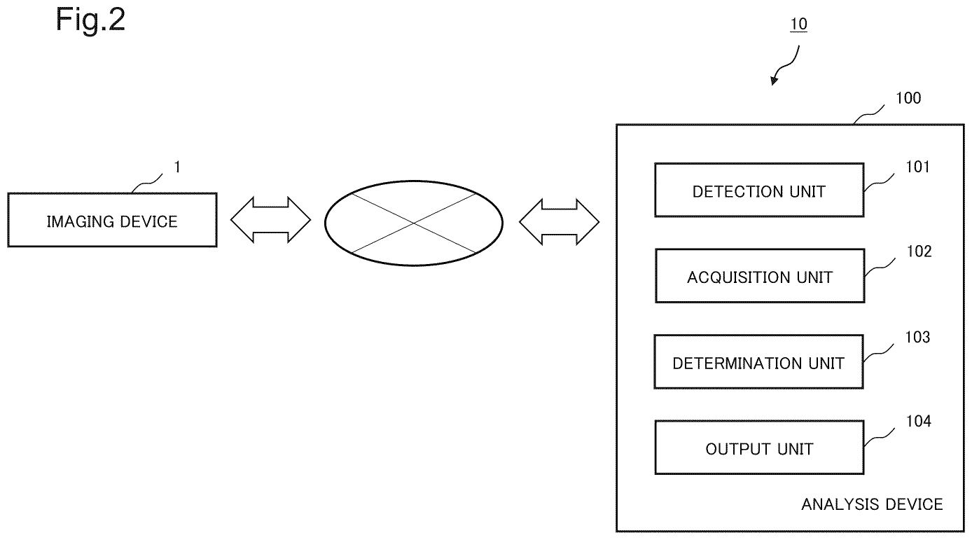

FIG. 2 is a block diagram illustrating a configuration example of the analysis system 10 according to the first example embodiment. In the analysis system 10, the analysis device 100 and the imaging device 1 are connected via a network. Referring to FIG. 2, the analysis device 100 includes a detection unit 101, an acquisition unit 102, an analysis unit 103, and an output unit 104.

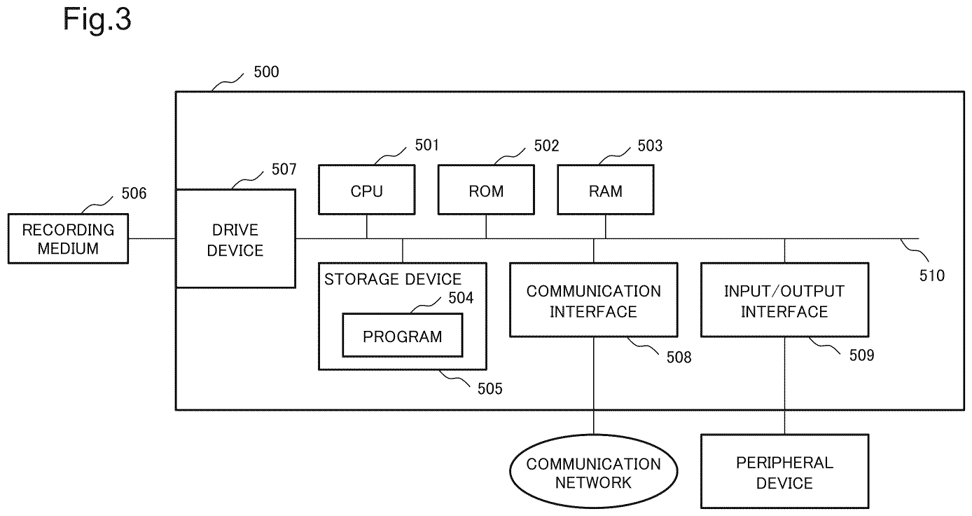

FIG. 3 is a diagram illustrating an example of a hardware configuration in which the analysis device 100 according to the first example embodiment of the present disclosure is achieved by a computer device 500 including a processor. The analysis device 100 is achieved by an information processing device such as a computer device, and includes a central processing unit (CPU) and a memory. The analysis method of the present disclosure may be implemented as an information processing method implemented by the above-described information processing device. As illustrated in FIG. 2, the analysis device 100 includes a CPU 501, a memory such as a read only memory (ROM) 502 and a random access memory (RAM) 503, a storage device 505 such as a hard disk that stores a program 504, a communication interface 508 for network connection, and an input/output interface 509 that inputs and outputs data. In the first example embodiment, the analysis device 100 is connected to each component via a bus 510. The analysis device 100 according to the first example embodiment illustrated in FIG. 1 can be configured by cloud computing or the like.

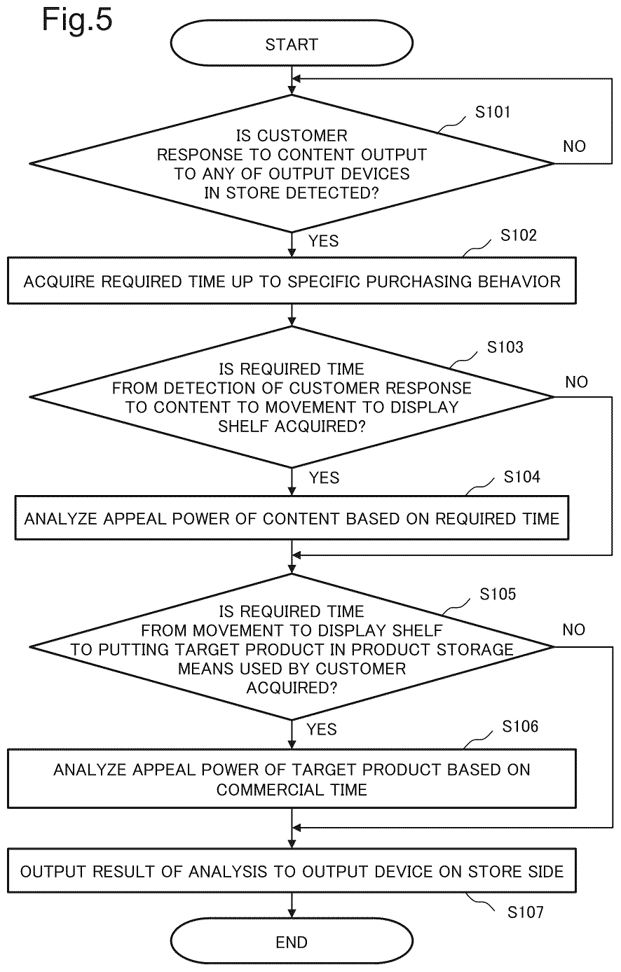

The CPU 501 operates the operating system to control the entire analysis device 100 according to the first example embodiment of the present invention. The CPU 501 reads a program and data from a recording medium 506 mounted on, for example, a drive device 507 to a memory. The CPU 501 functions as the detection unit 101, the acquisition unit 102, the analysis unit 103, the output unit 104, and a part thereof in the first example embodiment, and executes processing or a command in the flowchart illustrated in FIG. 5 to be described later based on a program.

The recording medium 506 is, for example, an optical disk, a flexible disk, a magnetic optical disk, an external hard disk, a semiconductor memory, or the like. A semiconductor memory or the like which is a part of the recording medium is a non-volatile storage device, and records a program therein. The program may be downloaded from an external computer (not illustrated) connected to a communication network.

As described above, the first example embodiment illustrated in FIG. 2 is implemented by the computer hardware illustrated in FIG. 3. However, the means that implements each unit included in the analysis device 100 of FIG. 2 is not limited to the configuration described above. The analysis device 100 may be implemented by one physically coupled device, or may be implemented by a system by connecting two or more physically separated devices in a wired or wireless manner.

The detection unit 101 is a means that detects the customer reaction to the content output to any of the output devices in the store. The reaction is a motion of the customer showing an interest in the content, and includes a behavior after viewing the content and a behavior after viewing the content. As the visual recognition of the content, the detection unit 101 may detect that the content is visually recognized in a case where the customer has visually recognized the content for a predetermined time or more. The detection unit 101 may detect that the contents of the products included in the same category are visually recognized a plurality of times by different output devices.

The detection unit 101 may detect a behavior that causes a customer to approach the output device as a behavior after viewing the content. The behavior also includes the line of sight of the customer. The detection unit 101 may detect a behavior of prompting the customer to see the content or movement in a display direction of a product displayed on the content. The detection unit 101 may detect that the customer is positive to the details of the content based on the movement of the mouth or the expression of the customer. The detection unit 101 may change the standard of the motion to be detected according to the attribute of the customer, or may detect the degree of interest in the product included in the content of the customer according to the content of the detected motion. However, the detection by the detection unit 101 is not limited to the above-described example, and a known method can be used. The detection unit 101 outputs, to the acquisition unit 102, appearance information such as a feature amount and an image that specifies the appearance of the customer who has reacted to the content.

The acquisition unit 102 is a means that acquires information pertaining to the purchasing behavior of the customer after detecting the customer reaction. In the present example embodiment, the acquisition unit 102 acquires, as the information pertaining to the purchasing behavior, the required time until the specific purchasing behavior of the customer after detection. The customer is a customer whose appearance matches that of a customer who has reacted to content. When the appearance information of the customer is input from the detection unit 101, the acquisition unit 102 acquires information pertaining to the purchasing behavior of the customer. The purchasing behavior is a behavior that a customer performs in a store before purchasing a target product.

In the present example embodiment, the purchasing behavior from the detection of the customer reaction to the content to movement of the customer to the display shelf of the target product is defined as a first purchasing behavior, and the purchasing behavior from the movement of the customer to the display shelf of the target product until the customer puts the target product into a product storage means is defined as a second purchasing behavior. The product storage means is a container for storing a product to be purchased by a customer, and is, for example, a shopping basket or a shopping cart. The shopping cart may be a smart shopping cart equipped with a product scanning function. In a case where the customer uses the product storage means equipped with the scanning function, the purchasing behavior from when the customer moves to the display shelf of the target product to when the customer scans the target product is the second purchasing behavior. The acquisition unit 102 may acquire the first purchasing behavior and the second purchasing behavior by analyzing image data captured by the same imaging device including the display shelf on which the target product is displayed in the imaging range. In this case, since both purchasing behaviors can be acquired from one image data, the load of image processing can be suppressed.

The acquisition unit 102 acquires that a specific purchasing behavior has been performed and the time when the purchasing behavior has been performed. The acquisition unit 102 analyzes image data obtained by capturing an image in front of the display shelf of the target product, and acquires the purchasing behavior of the customer. For example, the acquisition unit 102 analyzes the image data to acquire the purchasing behavior until the customer moves to the display shelf of the target product. By analyzing the image data, the acquisition unit 102 acquires the purchasing behavior of taking out the target product from the display shelf by the customer from the movement of the customer's arm, hand, or the like. The acquisition unit 102 may detect a change such as a decrease in the number of products in the display shelf by using image data captured by a camera in front of the display shelf on which the target product is displayed, and acquire a behavior in which the customer picks up the target product.

In the present example embodiment, the acquisition unit 102 can also acquire the purchasing behavior of the customer based on various types of sensor information provided in the display shelf, in addition to the image data captured by the imaging device. For example, an infrared sensor, a weight sensor, or the like may be provided on the display shelf to acquire the purchasing behavior of taking out the target product from the display shelf. For example, the weight sensor can detect a weight change of a target product placed on the display shelf. That is, in a case where it is detected that the weight of the display shelf on which the target product is placed has become light, the acquisition unit 102 acquires the purchasing behavior of the customer taking the target product from the display shelf.

The acquisition unit 102 acquires the imaging time associated with the captured image as the time at which the purchasing behavior is performed. When recognizing the behavior that the customer picks up the target product, the acquisition unit 102 acquires the behavior that the customer picks up the target product and the time. When recognizing that the customer has looked at the package of the product after picking up the target product, the acquisition unit 102 acquires the behavior of looking at the package of the product and the time thereof. When recognizing that the customer has put the target product into the product storage means, the acquisition unit 102 acquires the behavior of putting the target product into the product storage means and the time thereof, and when recognizing that the customer has returned the target product to the shelf, the acquisition unit 102 acquires the behavior of returning the target product to the shelf and the time thereof. For example, it is possible to grasp that there is a possibility that the customer purchases the target product by acquiring a behavior in which the customer puts the target product into the product storage means. By detecting that the customer returns the product to the shelf, it is possible to grasp that the customer has stopped purchasing the product. The acquisition unit 102 outputs the content of the purchasing behavior and the time when the purchasing behavior is performed to the analysis unit 103.

The analysis unit 103 is a means that performs analysis based on information pertaining to the purchasing behavior. In the present example embodiment, the analysis unit 103 analyzes the appeal power of the content based on the required time for the first purchasing behavior. For example, the analysis unit 103 calculates an average required time of the first purchasing behavior of the plurality of customers, and compares a preset standard time with the average required time. The standard time is not particularly limited as long as it is a reference time at which the appeal power can be analyzed, and is, for example, a required time for moving to the display shelf at an average walking speed of an adult. Then, the analysis unit 103 analyzes that the shorter the average required time of the first purchasing behavior is than the standard time, the higher the appeal power of the content is. On the other hand, the analysis unit 103 analyzes that the longer the average required time of the first purchasing behavior is than the standard time, the lower the appeal power of the content is. The analysis unit 103 may estimate attributes such as gender and age from the appearance of the customer and analyze the appeal power for each attribute. However, the analysis method of the appeal power of the content by the analysis unit 103 is not limited thereto.

The analysis unit 103 may analyze the appeal power of the target product based on the required time for the second purchasing behavior. For example, the analysis unit 103 calculates an average required time of the second purchasing behavior of the plurality of customers, and compares a preset standard time with the average required time. For example, the analysis unit 103 analyzes that the shorter the average required time of the second purchasing behavior is than the standard time, the higher the appeal power of the target product is. On the other hand, the analysis unit 103 analyzes that the longer the average required time of the second purchasing behavior is than the standard time, the lower the appeal power of the target product is. However, the analysis method of the appeal power of the target product by the analysis unit 103 is not limited thereto.

The output unit 104 is a means that outputs the results of analysis. The output unit 104 outputs the results of analysis to the output device on the store side. The output device on the store side is, for example, a display device in the backyard of the store or a display of a terminal carried by an employee. The output unit 104 may output the results of analysis to the terminal of a person in charge of the floor in which the target product is displayed.

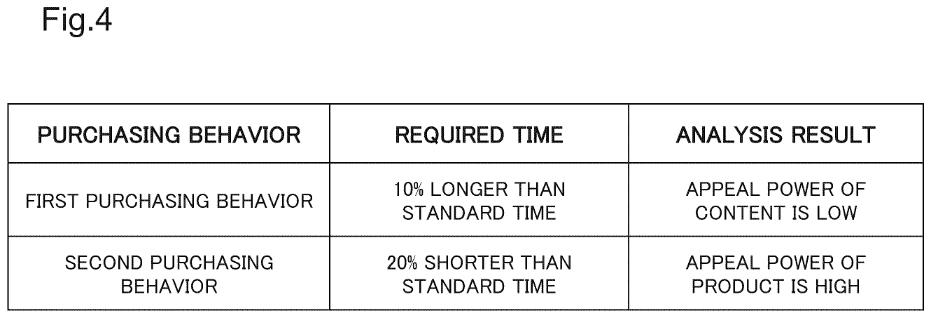

FIG. 4 is an output example of the results of analysis. As illustrated in FIG. 4, the difference between each purchasing behavior and the standard time of the required time is illustrated. In the example of FIG. 4, since the required time for the first purchasing behavior is longer than the standard time by 10%, the analysis unit 103 analyzes that the appeal power of the content is low. On the other hand, in the example of FIG. 4, since the required time for the second purchasing behavior is shorter than the standard time by 20%, it is analyzed that the appeal power of the product is high. However, the method of outputting the analysis result is not limited thereto.

FIG. 5 is a flowchart illustrating an operation of the analysis device 100 according to the first example embodiment. The processing according to this flowchart may be executed based on program control by the processor described above. The processing according to this flowchart is based on the premise that after the detection unit 101 detects the customer reaction to the content, the acquisition unit 102 acquires the required time for at least one of the first purchasing behavior and the second purchasing behavior.

FIG. 5 is a flowchart illustrating an operation of the analysis device 100 according to the first example embodiment. In a case where the detection unit 101 detects a customer reaction to the content output to any one of the output devices in the store (step S101; YES), the acquisition unit 102 acquires the required time for the specific purchasing behavior (step S102). In a case where the analysis unit 103 acquires the required time from the detection of the customer reaction to the content to the movement to the display shelf (step S103; YES), the appeal power of the content is analyzed based on the acquired required time (step S104). In a case where the analysis unit 103 has not acquired the required time from the detection of the customer reaction to the content to the movement to the display shelf (step S103; NO), the flow proceeds to step S105.

Next, in a case where the analysis unit 103 acquires the required time from the movement to the display shelf to the putting of the target product in the product storage means used by the customer (step S105; YES), the appeal power of the target product is analyzed based on the acquired required time (step S106). In a case where the analysis unit 103 has not acquired the required time until the target product is put into the product storage means used by the customer (step S105; NO), the flow proceeds to step S107. The output unit 104 outputs the results of analysis to the output device on the store side (step S107). Thus, the analysis device 100 ends the analysis process.

As described above, in the first example embodiment, the analysis device 100 analyzes the appeal power of the content or the product based on the required time until the specific purchasing behavior of the customer after the detection of the customer reaction to the content. Then, the output unit 104 outputs the results of analysis to the output device on the store side. As a result, for example, in a case where the ratio of customers whose required time until moving to the display shelf after reacting to the content has been within a predetermined time is large, it can be analyzed that there are many customers who are interested in the target product in the content and the details of the content are appealing. In a case where the ratio of customers whose required time from moving to the display shelf to putting the target product in the product storage means has been within a predetermined time is large, it can be analyzed that there are many customers who have decided to purchase immediately after looking at the target product, and the package of the target product is appealing. Therefore, according to the analysis device 100, the product in the content can be analyzed from a plurality of viewpoints.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

The analysis device 100 according to the first example embodiment performs analysis based on the required time for a specific purchasing behavior as information about the purchasing behavior. An analysis device 110 according to the second example embodiment performs analysis as the information pertaining to the purchasing behavior based on the motion of the customer at the time of the specific purchasing behavior.

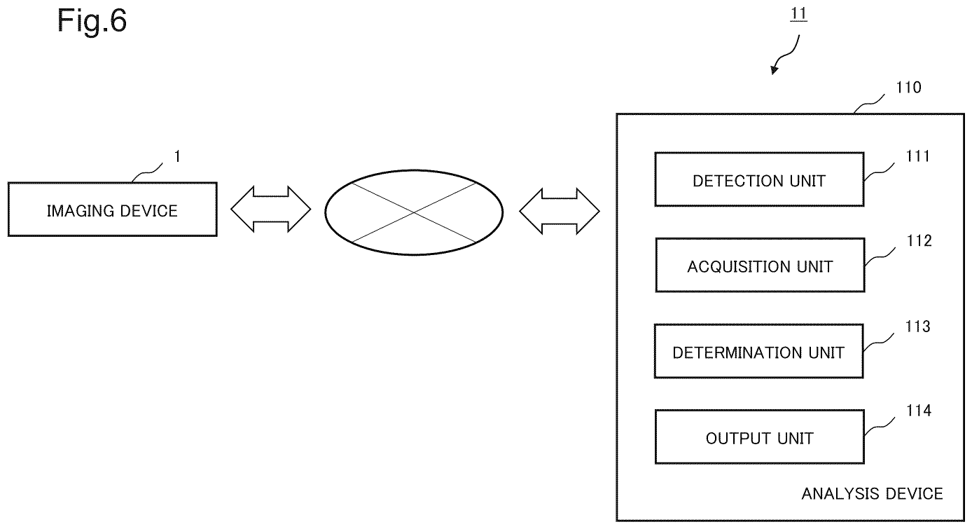

FIG. 6 is a block diagram illustrating a configuration example of an analysis system 11 including the analysis device 110 according to the second example embodiment. Similarly to the computer device illustrated in FIG. 3, the analysis device 110 can be achieved not only by hardware but also by a computer device or software based on program control.

Referring to FIG. 6, the analysis device 110 includes a detection unit 111, an acquisition unit 112, an analysis unit 113, and an output unit 114. The detection unit 111 has the same configuration and function as those of the detection unit 101 of the first example embodiment.

The acquisition unit 112 acquires a motion at the time of each purchasing behavior as information pertaining to the purchasing behavior of the customer. The acquisition unit 112 acquires the motion in the first purchasing behavior from the time when the customer reacts to the content to the time when the customer moves to the display shelf of the target product or the motion in the second purchasing behavior from the time when the customer moves to the display shelf to the time when the customer puts the target product in the product storage means.

The motion in the first purchasing behavior is an action that can indicate ease of finding the display place of the target product, such as a motion that searches for the display place of the target product. The motion in the second purchasing behavior is an action that can indicate the degree of interest in the target product, and is a motion such as where the customer is looking at the package of the product in front of the display shelf, whether the customer has put the product in the product storage means or not, how much the customer has looked at the product until the customer puts the product in the product storage means, or whether the customer has hesitated with another product. The motion described above is an example of the motion acquired by the acquisition unit 112, and is not limited thereto.

The acquisition unit 112 acquires the motion of the customer described above based on the movement of the hand of the customer, the positional relationship between the face direction of the customer and the target product held by the customer, the line-of-sight direction of the customer, or the like obtained from the image data captured by the imaging device. For example, the acquisition unit 112 may acquire which information of the package of the target product is visually recognized by the customer from the line-of-sight direction of the customer.

The acquisition unit 121 may acquire traffic line information of a customer. The traffic line information is generated by a traffic line generation means (not illustrated) and stored in the storage device 505 or the like. The acquisition unit 112 acquires the traffic line information of a customer whose appearance matches that of a customer who has reacted to the content from storage device 505. The traffic line generation means generates traffic line information by analyzing image data captured by an imaging device, for example. The traffic line information includes position information indicating a position of a customer. The position information is a set of time-series points indicating positions. The traffic line information may further include direction information indicating a direction of movement of the customer in addition to the position information. The direction information is obtained, for example, from a point indicating the position of the customer in time series. The traffic line information may also include a staying time indicating a time during which the customer is present at a specific position.

The method for generating the traffic line is not limited to the method described above. For example, the traffic line generation means may track the traffic line of the customer by detecting radio waves or infrared rays emitted from a beacon or the like installed in the product storage means used by the customer using a sensor. The traffic line generation means may generate the traffic line by tracking position information acquired from a customer terminal such as a tablet terminal provided in the shopping cart or a customer's own terminal. Further, the traffic line generation means may acquire a position where the speed of the traffic line of the customer suddenly increases or decreases based on the acceleration sensor installed in the product storage means.

An analysis unit 123 analyzes the validity of the display place of the target product or the appeal power of the target product based on the motion up to the specific purchasing behavior of the customer. The analysis unit 123 analyzes the validity of the display place of the target product based on the motion in the first purchasing behavior. Specifically, the analysis unit 123 analyzes that the display place is not valid if a predetermined ratio or more of customers who have moved to the display shelf of the target product take a motion in such a manner as to search for the display place of the target product for a predetermined time or more. On the other hand, the analysis unit 123 analyzes that the display place is valid in a case where the number of customers who exhibit a motion in such a manner as to search for the display place of the target product for a predetermined time or more is less than a predetermined ratio.

The analysis unit 123 may analyze the appeal power of the content based on traffic line information in the first purchasing behavior. For example, before coming to the display shelf of the target product, in a case where there is a predetermined ratio or more of customers who stay in another product or the floor for a certain period of time or more, or in a case where there is a predetermined ratio or more of customers whose traffic line speed is slow in front of another product or the floor, the analysis unit 123 may estimate that the customer has looked at another product more interesting than the target product in the content, and analyze that the appeal power of the content or the target product is low. The analysis unit 123 may specify another product looked at by the customer by analyzing the position information and the image data.

The analysis unit 123 analyzes the appeal power of the target product based on the motion in the second purchasing behavior. Specifically, in a case where the customer shows a motion of hesitating before putting the target product into the product storage means, hesitates with another product, or returns the target product to the display shelf, the analysis unit 123 estimates that the customer has shown an interest in the target product in the content, but has not felt an attraction as much as to immediately decide purchase for the target product. Therefore, the analysis unit 123 analyzes that the appeal power of the target product is low. The analysis unit 123 may analyze which part of the package the customer has hesitated or has not purchased. For example, in a case where the customer looks at the raw materials of the target product and returns the target product to the shelf, the analysis unit 123 estimates that an unfavorable material is included in the raw material. On the other hand, in a case where the customer takes out the target product from the display shelf and puts the target product into the product storage means within a predetermined time, the analysis unit 123 analyzes that the target product is appealing. In this case, the analysis unit 123 may specify which part of the target product has been looked at by the customer and analyze which part has been a deciding factor of purchase.

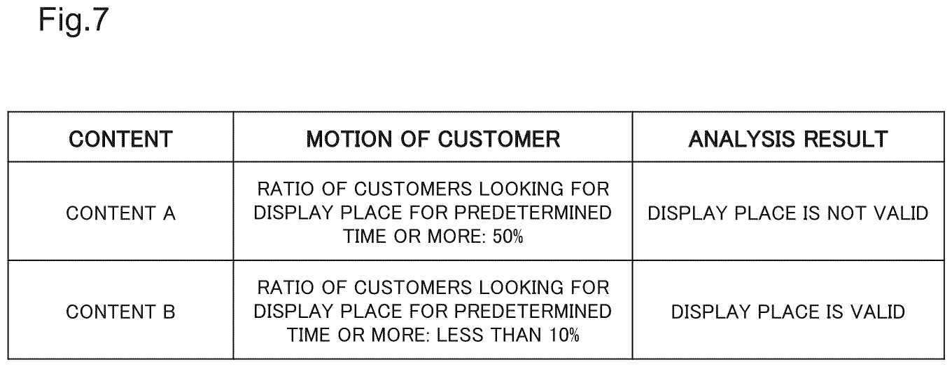

An output unit 124 outputs the results of analysis to the output device on the store side. FIG. 7 is an output example of the results of analysis on the appeal power of the content by the output unit 124. As illustrated in FIG. 7, the analyzed content name, the acquired behavior of the customer, and the analysis result are illustrated. In the example of FIG. 7, the acquisition unit 112 acquires that the ratio of customers who are searching for the display place for a predetermined time or more is 50% with respect to the motions of customers who have reacted to the content A. In this regard, the analysis unit 113 analyzes that the display place is not valid. The acquisition unit 112 acquires that the ratio of customers who are searching for the display place for a predetermined time or more is less than 10% with respect to the motions of customers who have reacted to the content B. In this regard, the analysis unit 113 analyzes that the display place is valid.

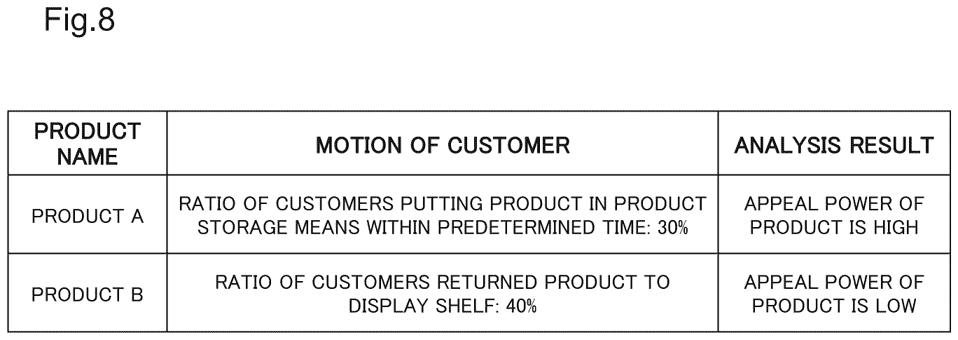

FIG. 8 is an output example of the results of analysis on the appeal power of the product. As illustrated in FIG. 8, the analyzed product name, the motion of the customer, and the analysis result are illustrated. In the example of FIG. 8, the acquisition unit 112 acquires, regarding the motion of the customer for the product A, that the ratio of customers who put the product in the product storage means within a predetermined time is 30%. In this regard, the analysis unit 113 analyzes that the appeal power of the product is high. The acquisition unit 112 acquires that the ratio of customers who has returned the product to the display shelf is 40% with respect to the motions of customers with respect to the product B. In this regard, the analysis unit 113 analyzes that the appeal power of the product is low. However, the method of outputting the analysis result is not limited thereto.

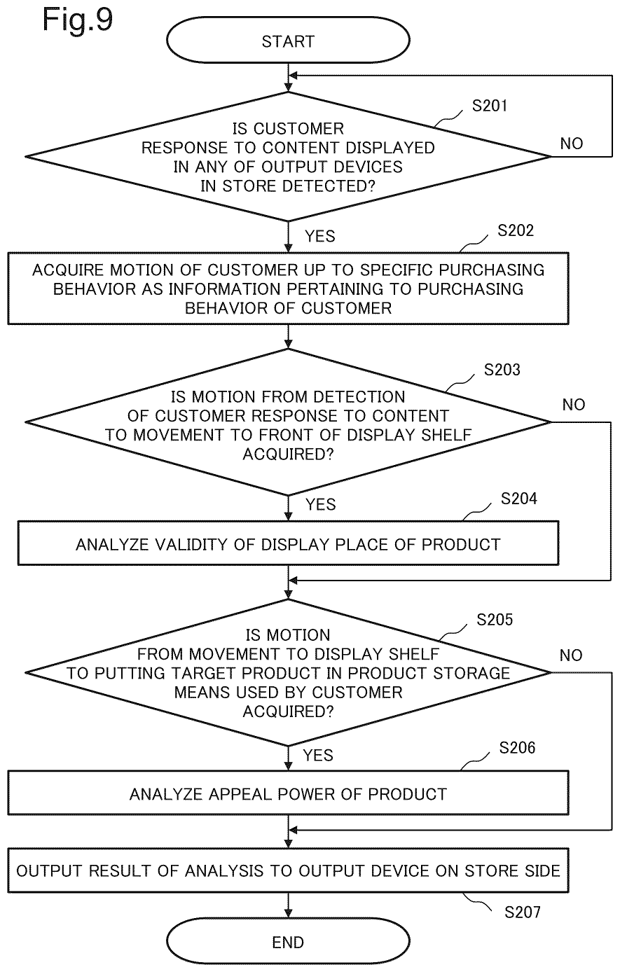

FIG. 9 is a flowchart illustrating an operation of the analysis device 110 according to the second example embodiment. The processing according to this flowchart may be executed based on program control by the processor described above. The processing according to this flowchart is based on the premise that after the detection unit 111 detects the customer reaction to the content, the acquisition unit 112 acquires the motion of the customer in at least one of the first purchasing behavior and the second purchasing behavior.

FIG. 9 is a flowchart illustrating an operation of the analysis device 110 according to the second example embodiment. In a case where the detection unit 111 detects a customer reaction to the content output to any one of the output devices in the store (step S201; YES), the acquisition unit 112 acquires the motion of the customer up to a specific purchasing behavior as the information pertaining to the purchasing behavior of the customer after the detection (step S202). In a case where the analysis unit 113 has acquired the motion from the detection of the customer reaction to the content to the movement to the display shelf of the target product (step S203; YES), the validity of the display place is analyzed based on the acquired motion (step S204). In a case where the analysis unit 113 has not acquired the motion from the detection of the customer reaction to the content to the movement to the display shelf of the target product (step S203; NO), the flow proceeds to step S205.

Next, in a case where the analysis unit 113 has acquired the motion from the movement to the display shelf to the putting of the target product in the product storage means used by the customer (step S205; YES), the appeal power of the product is analyzed based on the acquired motion (step S206). In a case where the analysis unit 113 has not acquired the motion until the target product is put into the product storage means used by the customer (step S205; NO), the flow proceeds to step S207. The output unit 114 outputs the results of analysis to the output device on the store side (step S207). Thus, the analysis device 110 ends the analysis process.

As described above, in the first example embodiment, the analysis device 110 analyzes the validity of the display place or the appeal power of the product based on the motion up to a specific purchasing behavior of the customer after the detection of the customer reaction to the content. Then, the output unit 114 outputs the results of analysis to the output device on the store side. As a result, for example, in a case where there are many customers who could move without hesitating until moving to the display shelf after reacting to the content, it can be analyzed that the display place is valid with respect to the output position of the content. In a case where there are many customers who have moved to the display shelf and then put the target product in the product storage means without hesitating, it can be analyzed that the target product is appealing. Therefore, the product in the content can be analyzed from a plurality of viewpoints.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

The purchasing behavior analyzed by the analysis units 103 and 113 is not limited to the information about the first purchasing behavior and the second purchasing behavior. For example, the analysis units 103 and 113 may analyze the appeal power of the product based on the information pertaining to the purchasing behavior from when the customer looks at the package of the product until putting the product into the product storage means, or may analyze the appeal power of the product based on the information pertaining to the purchasing behavior from when the customer picks up the product until returning the product to the display shelf.

### REFERENCE SIGNS LIST

10, 11 analysis system
100,110 analysis device
101, 111 detection unit
102, 112 acquisition unit
103, 113 analysis unit
104, 114 output unit
500 computer device
501 CPU
502 ROM
503 RAM
504 program
505 storage device
506 recording medium
507 drive device
508 communication interface
509 input/output interface
510 bus

What is claimed is:

1. An analysis device comprising:
one or more memories storing instructions; and
one or more processors configured to execute the instructions to:
detect a customer reaction to content that is output to any of output devices in a store;
acquire information pertaining to a purchasing behavior of the customer after the detection;
perform analysis based on the information pertaining to the purchasing behavior; and
output a result of analysis.

2. The analysis device according to claim 1, wherein the one or more processors configured to execute the instructions to:
acquire, as the information pertaining to the purchasing behavior, a required time for a specific purchasing behavior of the customer after the detection.

3. The analysis device according to claim 2, wherein the one or more processors configured to execute the instructions to:
acquire a required time in a first purchasing behavior from the detection to movement of the customer to a display shelf of a target product, and
analyze appeal power of the content based on the required time in the first purchasing behavior.

4. The analysis device according to claim 2, wherein the one or more processors configured to execute the instructions to:
acquire a required time in a second purchasing behavior from when the customer moves to the display shelf of the target product to when the customer puts the target product into a product storage means used by the customer, and
analyze appeal power of the target product based on the required time in the second purchasing behavior.

5. The analysis device according to claim 1, wherein the one or more processors configured to execute the instructions to:
acquire, as the information pertaining to the purchasing behavior of the customer, a motion up to a specific purchasing behavior of the customer after the detection.

6. The analysis device according to claim 5, wherein the one or more processors configured to execute the instructions to:
acquire a motion in a first purchasing behavior from the detection to movement of the customer to the display shelf of a target product, and
analyze validity of a display place of the target product based on the motion in the first purchasing behavior.

7. The analysis device according to claim 5, wherein the one or more processors configured to execute the instructions to:
acquire a second purchasing behavior until the customer puts a target product into a product storage means, and
analyze appeal power of the target product based on a motion in the second purchasing behavior.

8. The analysis device according to claim 5, wherein the one or more processors configured to execute the instructions to:
further acquire, as the information pertaining to the purchasing behavior of the customer, a traffic line up to a specific purchasing behavior of the customer after the detection, and
analyze validity of a display place of a target product or appeal power of the target product based on the traffic line.

9. An analysis method causing a computer to execute:
detecting a customer reaction to content output to any of output devices in a store;
acquiring information pertaining to a purchasing behavior of the customer after the detection;
performing analysis based on the information pertaining to the purchasing behavior; and
outputting a result of analysis.

10. A non-transitory recording medium storing a program for causing a computer to execute:
detecting a customer reaction to content output to any of output devices in a store;
acquiring information pertaining to a purchasing behavior of the customer after the detection;
performing analysis based on the information pertaining to the purchasing behavior; and
outputting a result of analysis.
